(19) United States
(12) Patent Application Publication
(10) Pub. No.: US 2018/0082202 A1
(43) Pub. Date: Mar. 22, 2018

(54) DEVICE AND METHOD FOR GENERATING A CRIME TYPE COMBINATION BASED ON HISTORICAL INCIDENT DATA

(71) Applicant: PUBLIC ENGINES, INC., Draper, UT (US)

(72) Inventor: Praneeth Vepakomma, Atlanta, GA (US)

(21) Appl. No.: 15/271,050

(22) Filed: Sep. 20, 2016

(51) Int. Cl. G06N 7/00; G06F 17/30

(52) U.S. Cl. CPC G06N 7/005; G06F 17/30241

(57) ABSTRACT

A device and method for generating a crime type combination based on historical incident data. The device includes a memory and an electronic processor. The memory includes historical incident data, which includes a plurality of incidents, each having a crime type. The electronic processor is configured to obtain a sample set of incidents from the historical incident data for each crime type of a plurality of unique crime type combinations. The electronic processor is configured to for each crime type combination, compute a distance correlation between the sample sets of incidents of crime types forming the crime type combination. The electronic processor is configured to select a crime type combination from the plurality of crime type combinations based on the distance correlations of the plurality of crime type combinations, and generate a crime prediction geographic area for the selected crime type combination.

### BACKGROUND OF THE INVENTION

Modern law enforcement agencies are tasked with crime prevention in addition to crime reaction and response. Crime prediction systems analyze historical data on crime incidents in a jurisdiction to predict the time and place of future crime incidents. This information may be used to direct law enforcement patrols in an effort to prevent the predicted crimes from taking place. Law enforcement agency personnel choose particular crime types (for example, burglary, auto theft, and assault) or combinations of crime types that they wish to prevent, and predictions are made based on the selections. Agency resources may thus be deployed in an attempt to prevent particular crimes or combinations of crimes.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of crime prediction system, in accordance with some embodiments.

FIG. 2 is a block diagram of a crime type combination prediction device, in accordance with some embodiments.

FIG. 3 is a flowchart of a method for incident location prediction based on historical incident data, in accordance with some embodiments.

FIG. 4 is a flowchart of a method for routing a responder based on a selected crime type combination, in accordance with some embodiments.

FIG. 5 is a bar chart showing distance correlation values for a plurality of crime type combinations, in accordance with some embodiments.

FIG. 6 illustrates a map including crime prediction geographic areas, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

One exemplary embodiment provides a crime type combination prediction device. The device includes a memory and an electronic processor coupled to the memory. The memory includes historical incident data. The historical incident data includes a plurality of incidents, which each have a crime type. The electronic processor is configured to obtain a sample set of incidents from the historical incident data for each crime type of a plurality of crime type combinations, each crime type combination including a unique combination of crime types. The electronic processor is configured to, for each crime type combination, compute a statistical dependency between the sample sets of incidents of crime types forming the crime type combination. The electronic processor is configured to select a crime type combination from the plurality of crime type combinations based on the statistical dependencies of the plurality of crime type combinations, and generate a crime prediction geographic area for the selected crime type combination.

Another exemplary embodiment provides a method for generating a crime type combination based on historical incident data that includes a plurality of incidents each having a crime type. The method includes obtaining, by an electronic processor, a sample set of incidents from the historical incident data for each crime type of a plurality of crime type combinations, where each crime type combination includes a unique combination of crime types. The method includes computing, by the electronic processor for each crime type combination, a statistical dependency between the sample sets of incidents of crime types forming the crime type combination. The method includes selecting, by the electronic processor, a crime type combination from the plurality of crime type combinations based on the statistical dependencies of the plurality of crime type combinations. The method includes generating, by the electronic processor, a crime prediction geographic area for the selected crime type combination.

For ease of description, some or all of the exemplary systems presented herein are illustrated with a single exemplar of each of its component parts. Some examples may not describe or illustrate all components of the systems. Other exemplary embodiments may include more or fewer of each of the illustrated components, may combine some components, or may include additional or alternative components.

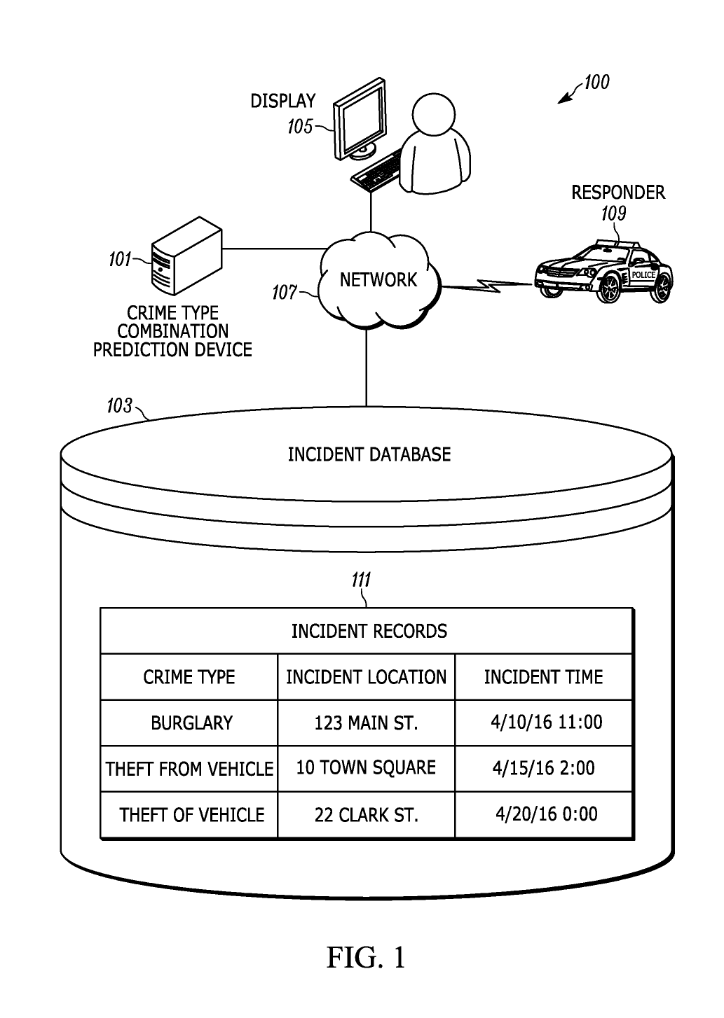

FIG. 1 is a block diagram of one exemplary embodiment of a crime prediction system 100. The crime prediction system 100 includes a crime type combination prediction device 101, an incident database 103, a display 105, a network 107, and a responder 109. In some embodiments, the crime prediction system 100 is integrated or co-located with a computer-aided dispatch system (not shown).

The crime type combination prediction device 101, described in greater detail below, is communicatively coupled to the incident database 103, which electronically stores information regarding incidents. An incident may be, for example, a crime or another occurrence for which a law enforcement officer may be dispatched to an area. The crime type combination prediction device 101 reads and writes such information to and from the incident database 103.

The incident database 103 is, for example, a relational database housed on a suitable database server (not shown); integrated with, or internal to, the crime type combination prediction device 101; or external to the crime prediction system 100 and accessible over the network 107. The incident database 103 stores historical incident data, for example, a plurality of incident records 111. Each of the plurality of incident records is populated in a row in the incident database 103. Each incident record includes a crime type (that is, what type of crime occurred), an incident location (that is, where the crime occurred), and an incident time (that is, the date and time when the crime occurred). For ease of illustration, each of the plurality of incident records 111 is shown having an address as the incident location. This should not be considered limiting. The incident location may be stored as another data type (for example, latitude and longitude coordinates).

The display 105 provides a human machine interface (HMI) to the crime prediction system 100. In one example, the display 105 is an electronic display screen or a computer communicatively coupled to the crime prediction system 100 via the network 107. In other embodiments, the display 105 may be a display screen of a computer server, a mobile computing device (for example, a smart telephone), or other electronic device communicatively coupled to the crime prediction system 100. In some embodiments, the display 105 is a display screen integrated with the crime type combination prediction device 101. The crime type combination prediction device 101 is configured to generate and display images on the display 105. In some embodiments (for example, where the display 105 is a touch screen), the display 105 may take input and communicate it to the crime prediction system 100 and the crime type combination prediction device 101

The network 107 may be a wired or wireless network. All or parts of the network 107 may be implemented using various existing networks, for example, a cellular network, the Internet, a land mobile radio (LMR) network, a Bluetooth™ network, a wireless local area network (for example, Wi-Fi), a wireless accessory Personal Area Networks (PAN), a Machine-to-Machine (M2M) autonomous network, and a public switched telephone network. The network 102 may also include future developed networks. The crime type combination prediction device 101, the incident database 103, the display 105, and the responder 109 communicate with each other over the network 107 using suitable wireless or wired communications protocols. In some embodiments, communications with other external devices (not shown) occur over the network 107.

In one exemplary embodiment, the responder 109 is a police squad car, equipped and configured to receive patrol routing information from the crime type combination prediction device 101. In alternative embodiments, the responder 109 may a patrol officer (for example, a foot or bicycle patrol officer) equipped to receive patrol routing information from the crime type combination prediction device 101.

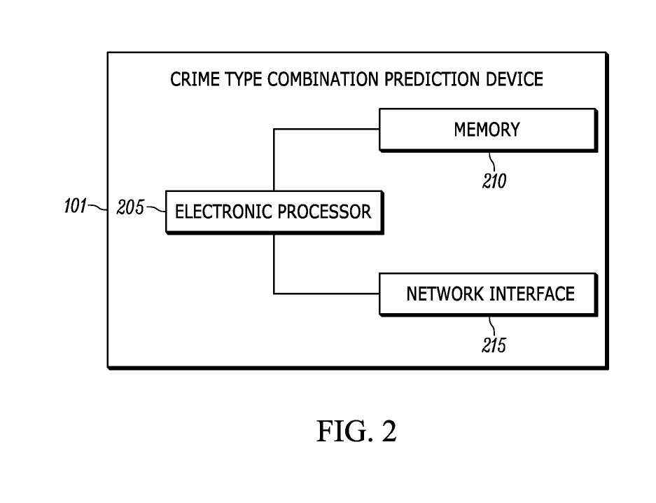

FIG. 2 is a block diagram of one exemplary embodiment of the crime type combination prediction device 101. In the embodiment illustrated, the crime type combination prediction device 101 includes an electronic processor 205 (for example, a microprocessor, or other electronic controller), a memory 210, and a network interface 215. The electronic processor 205, the memory 210, and the network interface 215, as well as the other various modules are coupled directly, by one or more control or data buses, or a combination thereof.

The memory 210 may include read-only memory (ROM), random access memory (RAM), other non-transitory computer-readable media, or a combination thereof. In some embodiments, the memory 210 stores sample sets of incidents, and crime type combinations, as described herein. The electronic processor 205 is configured to retrieve instructions and data from the memory 210 and execute, among other things, instructions to perform some or all of the methods described herein. As described more particularly below, in some embodiments, the electronic processor 205 generates a crime type combination based on the sample sets of incidents stored in the memory 210.

The electronic processor 205 controls the network interface 215 to send and receive data over the network 107, for example, to and from the incident database 103. For example, the network interface 215 may include a transceiver for wirelessly coupling to the network 107. Alternatively, or in addition, the network interface 215 may include a connector or port for receiving a wired connection (for example, Ethernet) to the network 107.

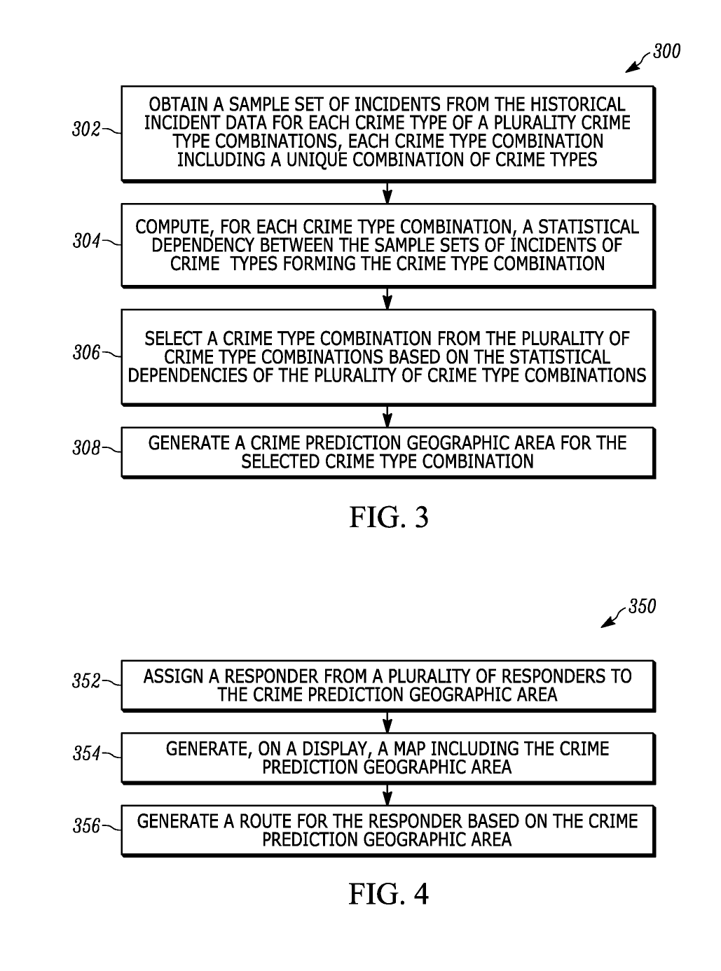

FIG. 3 is a flowchart of an exemplary method 300 for generating a crime type combination based on historical incident data. As an example, the method 300 is explained in terms of the electronic processor 205 of the crime type combination prediction device 101 accessing historical incident data in the incident database 103. Other embodiments of the method 300 may be performed on multiple processors within the same device or on multiple devices, and may access historical incident data from one or more other sources in place of or in addition to the incident database 103.

At block 302, the electronic processor 205 obtains a sample set of incidents from historical incident data (for example, from the plurality of incident records 111 stored in the incident database 103) for each crime type of a plurality of crime type combinations. As used herein, the term “crime type combination” refers to a grouping of two or more crime types (for example, burglary and theft from a vehicle, or theft of a vehicle and property crime). Each crime type combination is unique among the plurality of crime type combinations for which a sample set of incidents is obtained. In some embodiments, the sample sets must be of sufficient size (for example, a minimum of one thousand incidents) in order to yield reliable crime predictions. In such embodiments, the electronic processor 205 begins by retrieving the most recent incidents from the plurality of incident records 103, and proceeds to retrieve incidents in reverse chronological order until a sample set of sufficient size has been retrieved for each crime type.

At block 304, the electronic processor 205 computes, for each crime type combination, a statistical dependency between the sample sets of incidents of crime types forming the crime type combination. Statistical dependence measures the degree of relationship between two sets of data. For example, the records in each sample set may include a crime type, an incident time, an incident location. All of the records in one data set share a crime type, and all the records in the other data set share a different crime type. The statistical dependency between the two crime types is computed based on the other variables in the data sets (for example, the incident time and incident location). In one exemplary embodiment, the statistical dependency is a distance correlation that takes into account that the data sample sets is time-dependent—in this case, the incident time.

For each crime type combination, a sample set is obtained (at block 302) for each of the two crime types in the crime type combination. For example, a first crime type combination of the plurality of crime type combinations may have a first sample set of incidents for a first crime type and a second sample set of incidents for a second crime type. Computing statistical dependencies requires two identically-sized data sets. However, because the historical incident data is derived from actual crimes, the sizes of the first and second sample sets may differ. Accordingly, when one sample set of incidents is smaller than another sample set of incidents, the electronic processor 205 uses statistical resampling (for example, bootstrapping or jackknifing) to resample from the larger sample set of incidents using the smaller sample size of incidents. This resampling is repeated many (for example, one hundred) times to create many pairs of identically-sized sample sets for a crime type combination. In some embodiments, the electronic processor 205 computes a statistical dependency for each of the pairs of sample sets, and averages the results to compute a single statistical dependency for that crime type combination.

Although statistical dependence is limited to comparing two multivariate data sets, in some embodiments, a crime type combination may include more than two crime types. In such embodiments, the statistical dependence value is computed by computing the statistical dependence values in groups of two, and combining the values for each group (for example, by summing or averaging the values). For example, for a crime type combination including assault, armed robbery, and burglary, statistical dependence values are computed for combinations of assault/armed robbery, assault/burglary, and armed robbery/burglary. The resulting statistical dependence values may then be averaged to provide a statistical dependence value for the crime type combination.

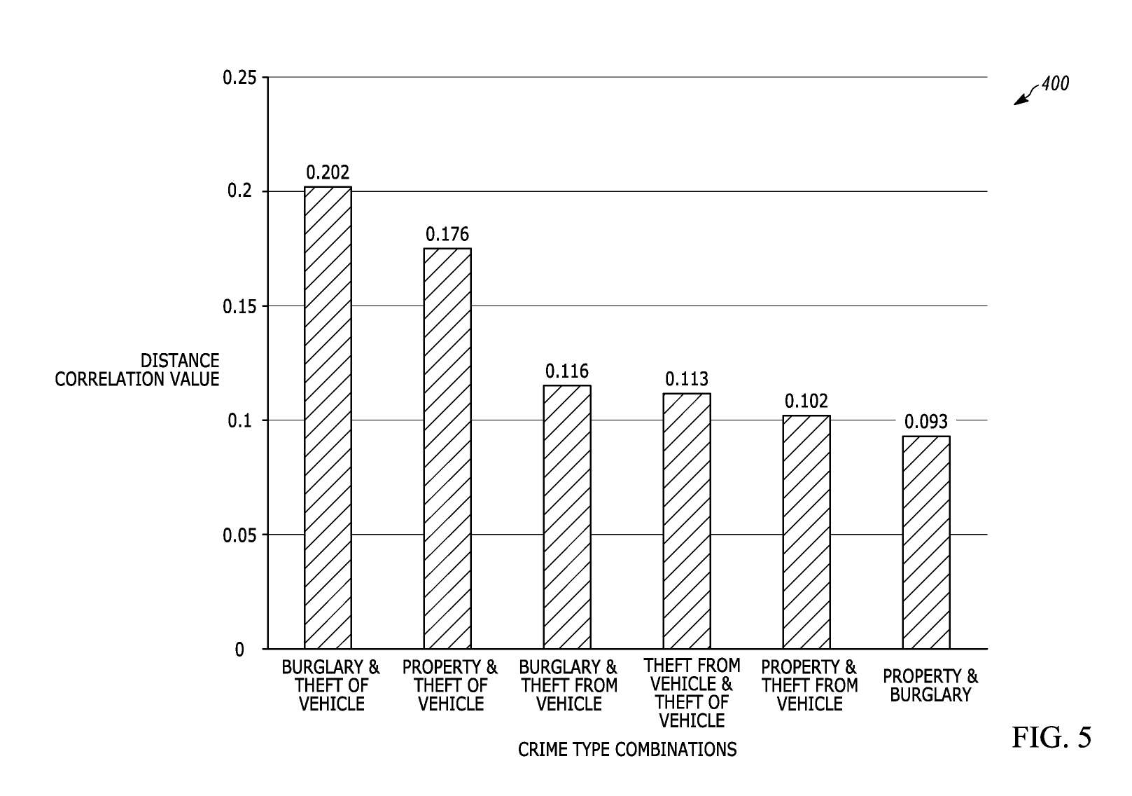

The result of block 304 is a statistical dependence (for example, distance correlation) value for each crime type combination. For example, FIG. 5 includes a bar chart 400 showing the distance correlation values for a plurality of crime type combinations. Other embodiments use other measures of statistical dependency.

Returning to FIG. 3, at block 306, the electronic processor 205 selects a crime type combination from the plurality of crime type combinations based on the statistical dependencies of the plurality of crime type combinations. In one embodiment, the electronic processor 205 compares the statistical dependencies of the plurality of crime type combinations (for example, the distance correlation values shown in bar chart 400 are in descending order) and selects the crime type combination with the maximum statistical dependency value.

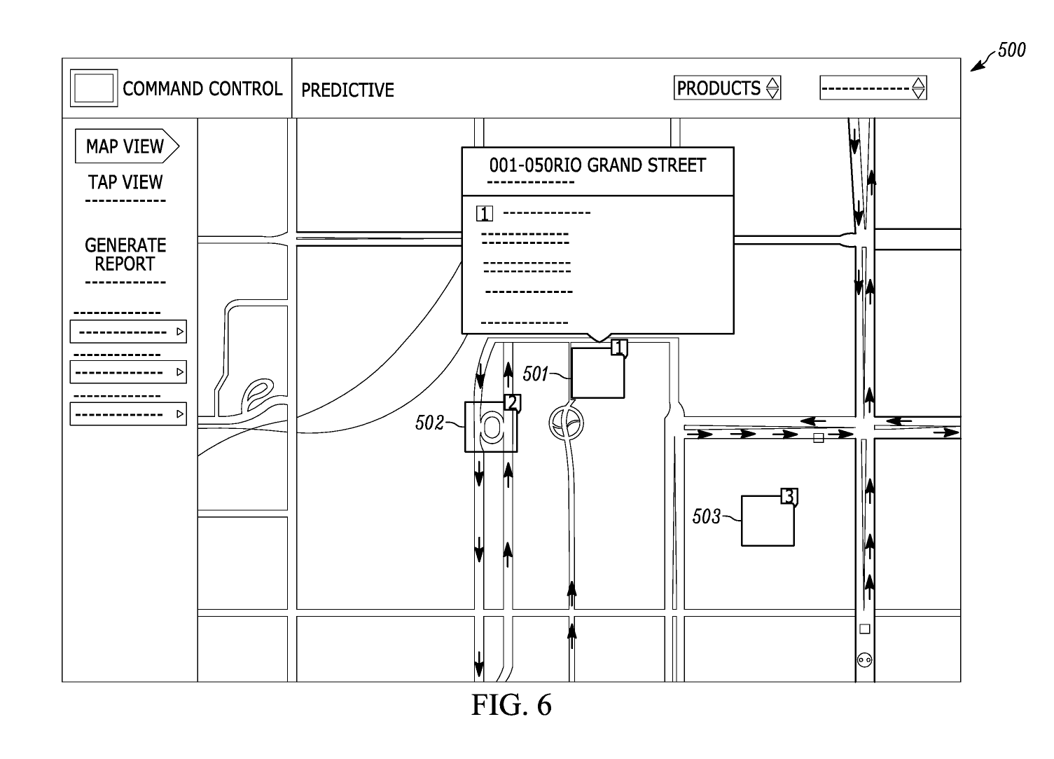

At block 308, the electronic processor 205 generates a crime prediction geographic area for the selected crime type combination using known or future-developed crime prediction system, for example the Motorola Solutions™ CommandCentral Predictive system. The generated crime prediction geographic area is an area within which the system predicts that crime incidents are likely to occur. The crime incidents are of one or more of the crime types in the selected crime type combination, and are likely to occur over the course of a particular time period (for example, a patrol shift). In some embodiments, the electronic processor 205 generates further crime prediction geographic areas for the selected crime type combination, and includes on a map the further crime prediction geographic areas (See FIG. 6, which illustrates a map 500, including crime prediction geographic areas 501, 502, and 503).

FIG. 4 is a flowchart of an exemplary method 350 for routing a responder based on a selected crime type combination generated using the method 300. At block 352, the electronic processor 205 assigns a responder (for example, the responder 109) from a plurality of responders (for example, a police force) to the crime prediction geographic area. The assigned responder is tasked with patrolling the crime prediction geographic area during its shift.

At block 354, the electronic processor 205 generates, on a display (for example, the display 105), a map (for example, the map 500) including the crime prediction geographic area. The map may be displayed, for example, on a display in a police dispatch center, on a display used by a patrol supervisor, or on a display used by the responder 109. The map may also display additional crime prediction geographic areas generated at block 308 of the method 300.

In some embodiments, at block 356, the electronic processor 205 generates a route for the responder based on the crime prediction geographic area or areas. For example, the responder 109 may be assigned a patrol route that ensures the responder 109 will visit the crime prediction geographic area at least once per hour (or at another rate) over the course of its shift. In some embodiments, the electronic processor 205 receives a plurality of crime prediction geographic areas and a list of multiple available responders (for example, those not currently responding to an incident or those responders working a shift) and assigns and routes at least one available responder from the list of available responders to each crime prediction geographic area. For example, the electronic processor 205 may use vehicle routing algorithms (for example, those used to solve the “traveling salesman problem”) to generate the assignments and routes.

Generating a crime prediction geographic area for each possible crime type combination for a group of crimes is not practically achievable because of the numbers involved. For example, the number of possible groups when there are ten crime types is 1,024. Generating predictions for 1,024 different groups may take weeks because the prediction process is computationally intensive. Furthermore, some crime types (for example, more prevalent crimes such as property crimes) may generate more areas than can be patrolled given the law enforcement resources available. Using the embodiments presented herein crime prediction geographic areas are only generated for selected crime type combinations. This results in a more efficient operation of the computer system, relative to a system that runs predictions for each possible crime type combination.

The embodiments presented herein maximize statistical dependencies between crime type data, which leads to greater predictive accuracy. This may be useful in situations where a smaller police agency does not have enough historical incident data to make predictions on any single crime type. In such cases, selecting crime type combinations as described herein provides for improved prediction accuracy over other crime type combinations.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A crime type combination prediction device comprising:
a memory including historical incident data, the historical incident data including a plurality of incidents each having a crime type; and
an electronic processor coupled to the memory and configured to
obtain a sample set of incidents from the historical incident data for each crime type of a plurality of crime type combinations, each crime type combination including a unique combination of crime types,
for each crime type combination, compute a statistical dependency between the sample sets of incidents of crime types forming the crime type combination,
select a crime type combination from the plurality of crime type combinations based on the statistical dependencies of the plurality of crime type combinations, and
generate a crime prediction geographic area for the selected crime type combination.

2. The device of claim 1, wherein a first crime type combination of the plurality of crime type combinations has a first sample set of incidents for a first crime type and a second sample set of incidents for a second crime type, the first sample set of incidents being smaller than the second sample set of incidents.

3. The device of claim 2, wherein computing the statistical dependency for the first crime type combination includes the electronic processor resampling the second sample set of incidents using a sample size of the first sample set of incidents.

4. The device of claim 1, wherein the electronic processor is configured to
compare the statistical dependencies of the plurality of crime type combinations; and
select the selected crime type combination from the plurality of crime type combinations based on the crime type combination with the maximum statistical dependency value.

5. The device of claim 1, wherein each of the plurality of incidents has an incident location and an incident time, and
wherein the electronic processor is configured to compute a statistical dependency between the sample sets of incidents of crime types forming the crime type combination based on the incident location and the incident time for each of the plurality of incidents.

6. The device of claim 1, wherein the statistical dependency is a distance correlation.

7. The device of claim 1, further comprising a display coupled to the electronic processor, the electronic processor configured to generate a map on the display including the crime prediction geographic area.

8. The device of claim 7, wherein the electronic processor is configured to
generate further crime prediction geographic areas for the selected crime type combination; and
include on the map the further crime prediction geographic areas.

9. The device of claim 7, wherein the electronic processor is configured to
assign a responder from a plurality of responders to the crime prediction geographic area,
generate a route for the responder based on the crime prediction geographic area.

10. A method for generating a crime type combination based on historical incident data that includes a plurality of incidents each having a crime type, the method comprising:
obtaining, by an electronic processor, a sample set of incidents from the historical incident data for each crime type of a plurality of crime type combinations, each crime type combination including a unique combination of crime types;
computing, by the electronic processor for each crime type combination, a statistical dependency between the sample sets of incidents of crime types forming the crime type combination;
selecting, by the electronic processor, a crime type combination from the plurality of crime type combinations based on the statistical dependencies of the plurality of crime type combinations; and
generating, by the electronic processor, a crime prediction geographic area for the selected crime type combination.

11. The method of claim 10, wherein a first crime type combination of the plurality of crime type combinations has a first sample set of incidents for a first crime type and a second sample set of incidents for a second crime type, the first sample set of incidents being smaller than the second sample set of incidents.

12. The method of claim 11, wherein computing the statistical dependency for the first crime type combination includes resampling the second sample set of incidents using a sample size of the first sample set of incidents.

13. The method of claim 10, further comprising:
comparing the statistical dependencies of the plurality of crime type combinations; and
selecting a crime type combination based on the crime type combination with the maximum statistical dependency value.

14. The method of claim 10, wherein each of the plurality of incidents has an incident location and an incident time, and
wherein computing a statistical dependency between the sample sets of incidents of crime types includes computing a statistical dependency based on the incident location and the incident time for each of the plurality of incidents.

15. The method of claim 10, wherein computing the statistical dependency for each crime type combination includes computing a distance correlation for each crime type combination.

16. The method of claim 9, further comprising:
generating, on a display coupled to the electronic processor, a map including the crime prediction geographic area.

17. The method of claim 16, further comprising:
generating further crime prediction geographic areas for the selected crime type combination; and
including on the map the further crime prediction geographic areas.

18. The method of claim 16, further comprising:
assigning a responder from a plurality of responders to the crime prediction geographic area,
generating a route for the responder based on the crime prediction geographic area.
